(19) United States
(12) Patent Application Publication
(10) Pub. No.: US 2016/0097485 A1
(43) Pub. Date: Apr. 7, 2016

(54) HOIST SYSTEM

(71) Applicant: KB Energy, LLC, Arlington, WY (US)

(72) Inventor: Keith D. Broyles, Arlington, WY (US)

(21) Appl. No.: 14/877,697

(22) Filed: Oct. 7, 2015

Related U.S. Application Data
(60) Provisional application No. 62/060,978, filed on Oct. 7, 2014.

(51) Int. Cl. F16M 13/02; H04R 1/02

(52) U.S. Cl. CPC F16M 13/022; H04R 1/02

(57) ABSTRACT

Embodiments of the present disclosure relate to providing a hoist system that raises and lowers a cable car on a hoist cable next to a mast. A monitoring device such as a microphone may be positioned on the cable car, and the hoist system raises the monitoring device on the cable car to an elevated position above a ground surface to better monitor the surrounding environment. An upper pulley assembly can be interconnected to the mast and serve as an upper terminus for the hoist cable. Several components of the present disclosure align the cable car with the upper pulley assembly. For example, an upper plate of the cable car may have one or more guide plates that channel the cable car toward the upper pulley assembly, and the cable car and the upper pulley assembly may have locating members to selectively interconnect to each other.

### CROSS REFERENCE TO RELATED APPLICATIONS

The present application claims the benefit of U.S. provisional patent application Ser. No. 62/060,978, filed Oct. 7, 2014, the entire disclosure of which is hereby incorporated herein by reference.

### FIELD

Embodiments of the present disclosure are generally directed to a hoist system. More particularly, hoist systems suitable for raising microphones or other monitoring equipment on metrology masts or towers are provided.

### BACKGROUND

It is often desirable to raise environmental monitoring devices on metrology masts. For example, microphones and sound recording equipment can be raised on metrology masts to monitor bats. This elevated position allows microphones and sound recording equipment to better monitor bats as the bats fly through the air. The elevated position of monitoring devices is also advantageous in other fields. For example, meteorology equipment such as an anemometer provides more accurate readings at an elevated position compared to a position on the ground.

However, previous systems for raising and lowering such equipment have been difficult to use, unreliable, and have not provided a secure mounting for the equipment when it is in a raised configuration. Cabling in previous systems often becomes loose or broken in high winds. Further, if the cabling becomes loose or free, then the cabling is prone to hitting or slapping the mast, which negatively affects the data being recorded by the monitoring devices.

Another issue with previous systems for raising and lowering monitoring devices is that the systems are positioned next to a structure such as a mast. Incidental contact between a system and the mast can damage sensitive monitoring devices. Accordingly, previous systems reduce the effectiveness and longevity of monitoring devices.

### SUMMARY

In accordance with embodiments of the present disclosure, hoist systems are provided that are relatively easy to use, and that operate reliably and securely to raise and lower monitoring devices or other equipment. A hoist system as disclosed herein can include an upper pulley assembly, a hoist cable operably interconnected to the upper pulley assembly, and a cable car interconnected to the hoist cable. The cable car can be raised to selectively interconnect with the upper pulley assembly and maintain the cable car, and any monitoring devices attached thereto, at an elevated position above the ground surface.

The hoist system may comprise one or more components to guide or channel the cable car toward the upper pulley assembly as the cable car is raised, and then selectively interconnect the cable car to the upper pulley assembly to hold the cable car at an elevated position above the ground. The cable car can have one or more guide plates on an upper plate of the cable car to guide the cable car toward the upper pulley assembly. The guide plates can extend away from the center of the cable car at an angle such that the area between the guide plates increases as the guide plates extend away from the cable car. Therefore, as the guide plates contact the lower plate of the upper pulley assembly, the cable car increasingly aligns with the upper pulley assembly.

Once the cable car and the upper pulley assembly are within a threshold distance from each other, a locating member positioned on the upper plate of the cable car can selectively interconnect the cable car to the upper pulley assembly. In some embodiments, the locating member is a magnet or a magnetic area of the upper plate. In other embodiments where a second magnet is placed on the lower plate of the upper pulley assembly, the two magnets can have opposing polarities such that when the cable car is sufficiently close to the upper pulley assembly, the magnets attract to each other and selectively interconnect the cable car to the upper pulley assembly.

The hoist system may comprise a particular aperture configuration on the cable car and the upper pulley assembly to accommodate the hoist cable and further align the cable car and the upper pulley assembly. For example, the upper plate of the cable car may comprise an aperture on either side of the locating member on the upper plate. A portion of the hoist cable passes through either aperture. Similarly, the lower plate of the upper pulley assembly can comprise two corresponding apertures. A portion of the hoist cable passes through either aperture in the lower plate and is positioned in at least one pulley in the upper pulley assembly. In this configuration, the hoist cable and the apertures align the cable car and the upper pulley assembly as the cable car is raised toward the upper pulley assembly. Further, the hoist cable and the apertures protect against torsional or twisting movements of the cable car relative to the upper pulley assembly.

The hoist assembly may also comprise a bracing assembly to prevent incidental contact between the cable car and the structure that the hoist system is fixed to, such as a mast. The bracing assembly can comprise at least one pulley, and the hoist cable is positioned in the at least one pulley. The bracing assembly extends the at least one pulley and the hoist cable away from a longitudinal axis of the mast by a distance that, in some embodiments, is larger than the distance between the at least one pulley of the upper pulley assembly and the longitudinal axis of the mast. Thus, the cable car is positioned away from the mast as the cable car is raised and lowered to prevent incidental contact between the cable car and the mast.

A hoist system as disclosed herein can also include a winch assembly and a winch line. The winch line can include a pulley or other interconnection to the hoist cable to which the cable car is fixed. A mounting plate or member can be provided as part of the cable car, to which monitoring equipment can be attached.

Additional features and advantages of embodiments of the present disclosure will become more readily apparent from the following description, particularly when taken together with the accompanying drawings.

### BRIEF DESCRIPTION OF THE DRAWINGS

FIG. 1 depicts a mast and an attached hoist system in accordance with embodiments of the present disclosure;

FIGS. 2A-2C depict a cable car in accordance with embodiments of the present disclosure;

FIGS. 3A-3D depict an upper pulley assembly in accordance with embodiments of the present disclosure;

FIG. 4 depicts a hoist system with a cable car and an upper pulley assembly in accordance with embodiments of the present disclosure;

FIG. 5 depicts a hoist system with a cable car and an upper pulley assembly in a raised configuration in accordance with embodiments of the present disclosure;

FIGS. 6A and 6B depict a winch assembly in accordance with embodiments of the present disclosure; and

FIGS. 7A and 7B depict a bracing assembly in accordance with embodiments of the present disclosure.

### DETAILED DESCRIPTION

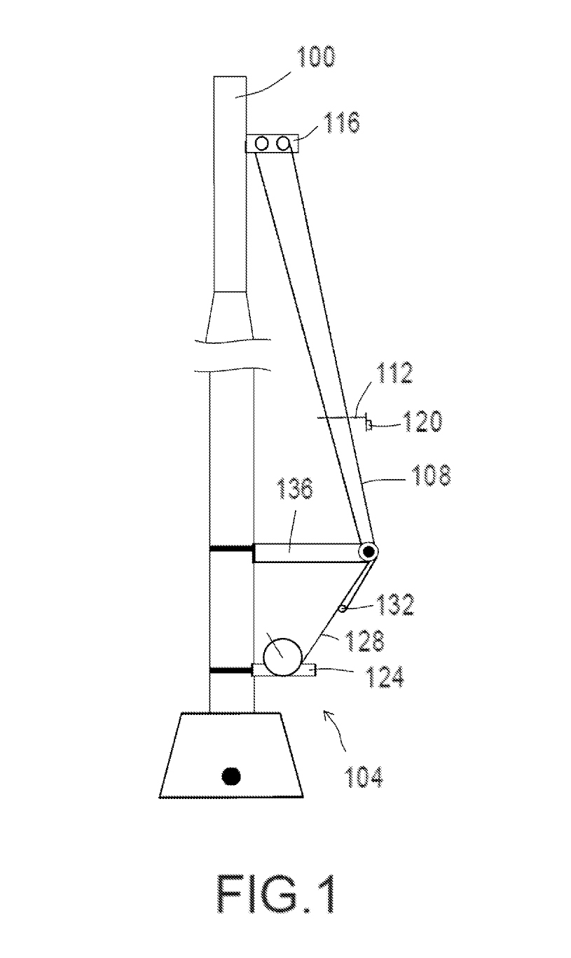

FIG. 1 depicts a mast or tower 100 and an attached hoist system 104 in accordance with embodiments of the present disclosure. The hoist system 104 can include a hoist cable 108, generally configured as a loop, a cable car 112 that is fixed to the hoist cable 108, and an upper pulley assembly 116 that has at least one pulley in which the hoist cable 108 is positioned. Specifically, the top of the loop formed by the hoist cable 108 is positioned in the at least one pulley of the upper pulley assembly 116. The hoist cable 108 is rotated or otherwise moved to raise or lower the cable car 112. When the cable car 112 is in a raised position, the cable car 112 is selectively interconnected to the upper pulley assembly 116, which may serve as an upper terminus for the cable car 112. A monitoring device 120 or other system, including but not limited to a microphone, can be positioned on the cable car 112, and thus maintained at an elevated position above a ground surface when the cable car 112 is selectively interconnected to the upper pulley assembly 116.

Although the hoist system 104 is described and is shown in various figures as being attached to a mast 100, such as a metrology mast, it should be appreciated that the hoist system 104 can be used in connection with raising a monitoring device 120 or other system to a desired height along a lattice type tower, a building, or other manmade structure, or up a tree, cliff or other natural structure.

In accordance with at least some embodiments, a winch cable 128 can be connected to the hoist cable 108 by a pulley 132 that allows the leg of the hoist cable to which the cable car 112 is attached to be raised or lowered, while the bottom of the loop formed by the hoist cable 108 is held by the winch cable 128. By operating the winch assembly 124, a user can apply tension to the hoist cable 108, for example after the hoist cable 108 has been used to place the cable car 112 into a raised position in which it is in contact with the upper pulley assembly 116. A user can also operate the winch assembly 124 so as to release tension from the hoist cable 108, for example, when raising or lowering the cable car 112.

Alternatively, the bottom of the loop formed by the hoist cable 108 can be positioned in the winch assembly 124, and the winch assembly 124 directly drives the rotation or movement of the hoist cable 108 to raise and lower the cable car 112. In these embodiments, one or more tensioner pulleys may be incorporated to add tension to the hoist cable 108 to prevent the cable car 112 and the monitoring device 120 from contacting the mast 100.

A bracing assembly 136 can also be provided to the hoist system 104. The bracing assembly 136 can assist in maintaining a desired spacing between the mast 100 and the hoist cable 108, and can provide stability to the hoist cable 108 while the cable car 112 is being raised or lowered. The hoist cable 108 can be positioned in at least one pulley of the bracing assembly 136, and the desired spacing between the mast 100 and the hoist cable 108 may be expressed in terms of distance between the at least one pulley of the bracing assembly 136 and a longitudinal axis of the mast 100. This distance may be greater than, less than, or equal to the distance between the at least one pulley of the upper pulley assembly and the longitudinal axis of the mast 100. The desired spacing provided by the bracing assembly 136 prevents incidental contact between the cable car 112 and the mast 100, and thus damage to the monitoring device 120.

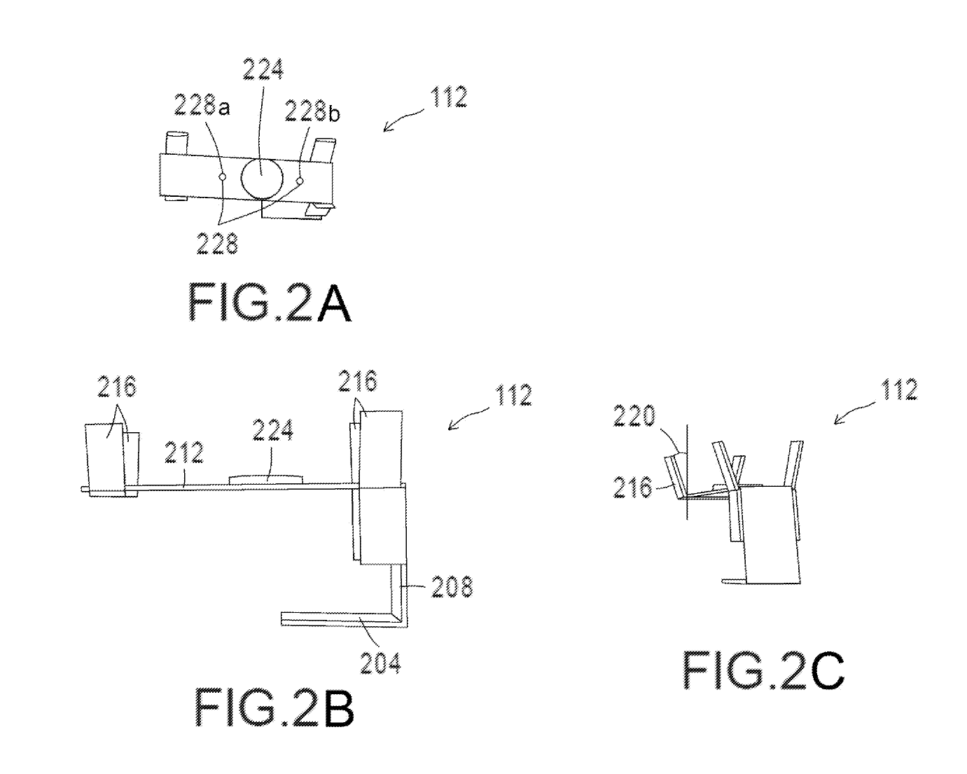

FIGS. 2A-2C depict a cable car 112 in accordance with embodiments of the present disclosure. The cable car 112 generally includes a cable mount or ear 204, a mounting plate 208, and a top plate 212. The cable mount 204 can include provisions for fixing the cable car 112 to the hoist cable 108. In accordance with at least some embodiments of the present disclosure, the two ends of the hoist cable 108 are joined to the cable car at the cable mount 204, such that the hoist cable 108 forms a loop. Alternatively, the cable mount 204 may be an optional component of the hoist system 104, and the hoist cable 108 is interconnected to another part of the cable car 112, for example, the mounting plate 208 or the top plate 212.

The mounting plate 208 links the cable mount 204 and the top plate 212 and provides a surface to which a monitoring device 120 can be mounted. In accordance with at least some embodiments of the present disclosure, the mounting plate 208 can include mounting members, holes, or other provisions for facilitating attachment of one or more monitoring devices 120 to the cable car 112. In addition, the mounting plate 208 can comprise characteristics that enhance the performance of the monitoring device 120 or devices. In some embodiments, the mounting plate 208 may comprise a material with acoustically reflective or acoustically absorptive properties. For example, wood, metal, and masonry are acoustically reflective while acoustically absorptive materials are generally pliable and porous such as foam or cloth. Further, the mounting plate 208 may have a geometric design or shape to enhance the performance of the monitoring device 120.

A set of guide plates 216 can align the cable car 112 with the upper pulley assembly 116 as the cable car 112 is raised. Specifically, the guide plates 216 align the lateral, or side-to-side, dimension of the cable car 112 with the lower plate of the upper pulley assembly. In this embodiment, the cable car 112 has four guide plates 216 that extend upwardly from a plane defined by an upper surface of the top plate 212. In accordance with at least some embodiments of the present disclosure, the guide plates 216 may be angled so that they form a wider opening at the top of the guide plates 216 than at the bottom to assist in guiding the cable car 112 into alignment with the upper pulley assembly 116. Specifically, the wider opening formed by the guide plates 216 provides a larger area to catch or receive a lower plate of the upper pulley assembly 116. As the hoist cable 108 moves and the cable car 112 is raised, the guide plates 216 guide or channel the cable car 112 until the cable car 112 is aligned with the upper pulley assembly 116.

A plate angle 220 can define the angle that the guide plates 216 form with the upper surface of the top plate 212. In some embodiments, the plate angle 220 may be between approximately 20 and 40 degrees. It should be appreciated that the plate angle 220 defines the angle that the guide plates 216 extend away from the sides of the top plate 212. In other embodiments, a second plate angle can define the angle that the guide plates 216 extend away from the ends of the top plate 212. In addition, one or more guide plates 216 may be positioned on the end or ends of the top plate 212 of the cable car 112. It should be further appreciated that other embodiments of the cable car 112 may comprise fewer or greater than four guide plates 216. Additionally, in other embodiments, one or more guide plates 216 can be oriented perpendicular to the upper surface of the top plate 212, and the one or more guide plates 216 are received within corresponding recesses in the lower plate of the upper pulley assembly 116.

Alternatively or in addition, the cable car 112 can include a locating member 224 such as a magnet that selectively interconnects the cable car 112 to the upper pulley assembly 116. The locating member 224 can mounted to the top plate 212 such that it is brought into contact with the lower plate of the upper pulley assembly 116 when the cable car 112 is in a raised position. The locating member 224 can thus provide a magnetic force that joins the cable car 112 to the upper pulley assembly 116 when the cable car 112 is raised. In some embodiments, the material of the upper pulley assembly 116 is magnetic, and the magnetic force between the locating member 224 and the upper pulley assembly 116 is sufficient to selectively interconnect the cable car 112 to the upper pulley assembly 116. In other embodiments, another locating member is mounted on the lower plate of the upper pulley assembly 116. When the locating members are magnets, the magnets may have opposing polarities such that there is an attractive magnetic force between the locating member on the cable car 112 and the locating member on the upper pulley assembly 116. Other locating members can include mechanical systems such as a ratchet and pawl system.

Apertures 228 can be positioned in the top plate 212 of the cable car 112 to permit the hoist cable 108 to pass through the cable car 112. In the depicted embodiment, a first aperture 228a is positioned on one side of the locating member 224, and a second aperture 228b is positioned on the other side of the locating member 224. In operation, one leg of the hoist cable 108 is positioned in the first aperture 228a, and another leg of the hoist cable 108 is positioned in the second aperture 228b. The point at which the hoist cable 108 is interconnected to the cable mount 204 can be positioned directly below the second aperture 228b so that the leg of the hoist cable 108 positioned in the second aperture 228b remains substantially perpendicular to the top plate 212. It should be appreciated that there can be a variety of aperture and locating member configurations. For example, in some embodiments, there is only one aperture in the top plate, and a locating member is positioned on either side of the single aperture. In this configuration, one leg of the hoist cable 108 is positioned in the single aperture, and the other leg of the hoist cable 108 is positioned outside of the cable car 112 altogether.

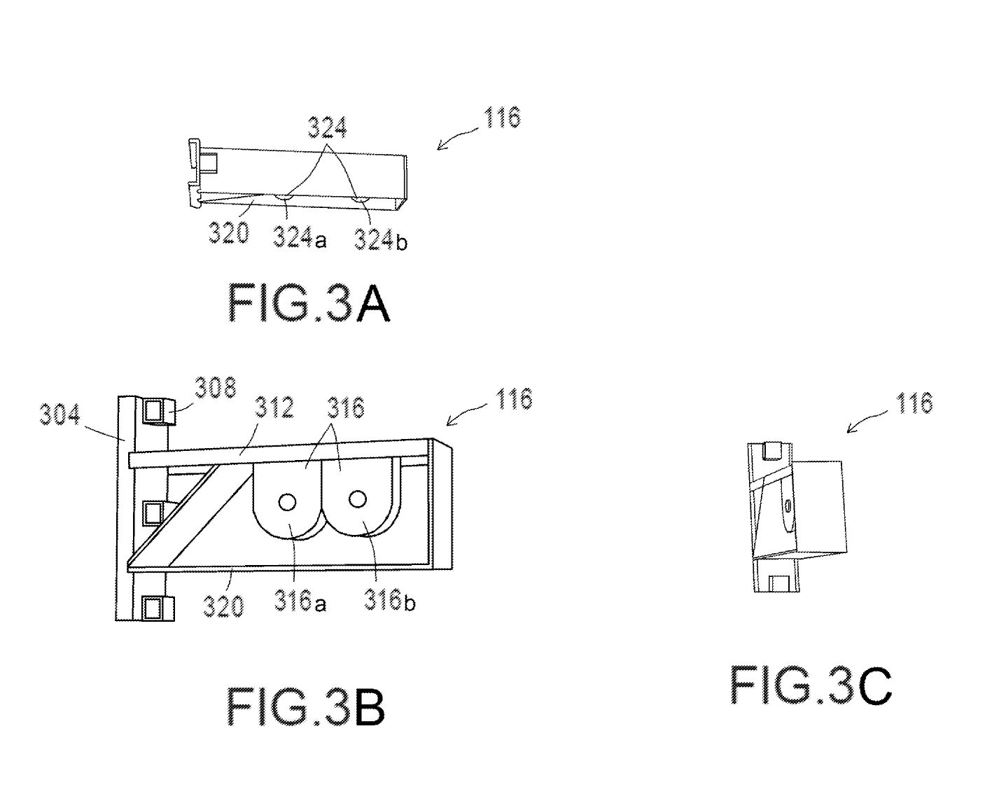

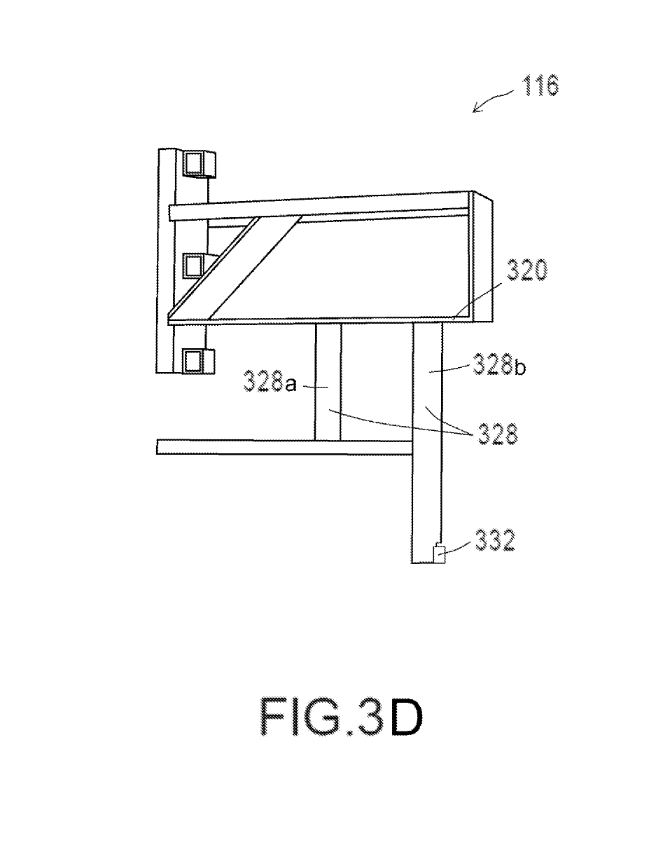

FIGS. 3A-3D depict an upper pulley assembly 116 in accordance with embodiments of the present disclosure. A mounting plate 304 is configured to abut a mast 100 or tower. One or more band clamp guides 308 can be interconnected to the mounting plate 304 to provide a location for band clamps to secure the upper pulley assembly 116 to the mast 100.

An upper pulley frame 312 extends from the mounting plate 304. In this embodiment, the upper pulley frame 312 is perpendicular to the mounting plate 304. A first pulley 316a and a second pulley 316b are mounted to the underside of the upper pulley frame 312. The top of the loop formed by the hoist cable 108 is positioned in these pulleys 316a, 316b, which allow for the movement of the hoist cable 108.

Next, a lower plate 320 extends from the mounting plate 304. In this embodiment, the lower plate 320 is perpendicular to the mounting plate 304. As described above, the lower plate 320 is the component of the upper pulley assembly 116 that the guide plates 216 of the cable car 112 are configured to contact. Also as described above, the lower plate 320 may be comprised of magnetic material so that a magnet on the cable car 112 may attract to the lower plate 320 and selectively interconnect the cable car 112 to the upper pulley assembly 116. The lower plate 320 may optionally comprise a locating member such as a magnet with an opposing polarity to the magnet on the cable car 112 to promote the selective interconnection of the cable car 112 to the upper pulley assembly 116.

As shown in FIG. 3A, a first aperture 324a and a second aperture 324b are positioned on the lower plate 320 to allow legs of hoist cable to pass through the lower plate 320. In this embodiment, the apertures 324a, 324b are spaced apart to correspond to the spacing of the apertures in the top plate 212 of the cable car 112. Therefore, an optional second locating member or magnet can be positioned between the apertures 324a, 324b. In addition, just as the apertures and locating members of the cable car may have various configurations, the apertures and locating members of the lower plate 320 may have corresponding configurations. However, it should be appreciated that it may be advantageous to have differing aperture and locating member configurations between the cable car and the upper pulley assembly.

As shown in FIG. 3D, the lower plate 320 can be associated with guide tubes 328a, 328b where an adapter 332 positioned on a distal end of at least one of the guide tubes 328 is configured to receive a corresponding component mounted on the cable car 112.

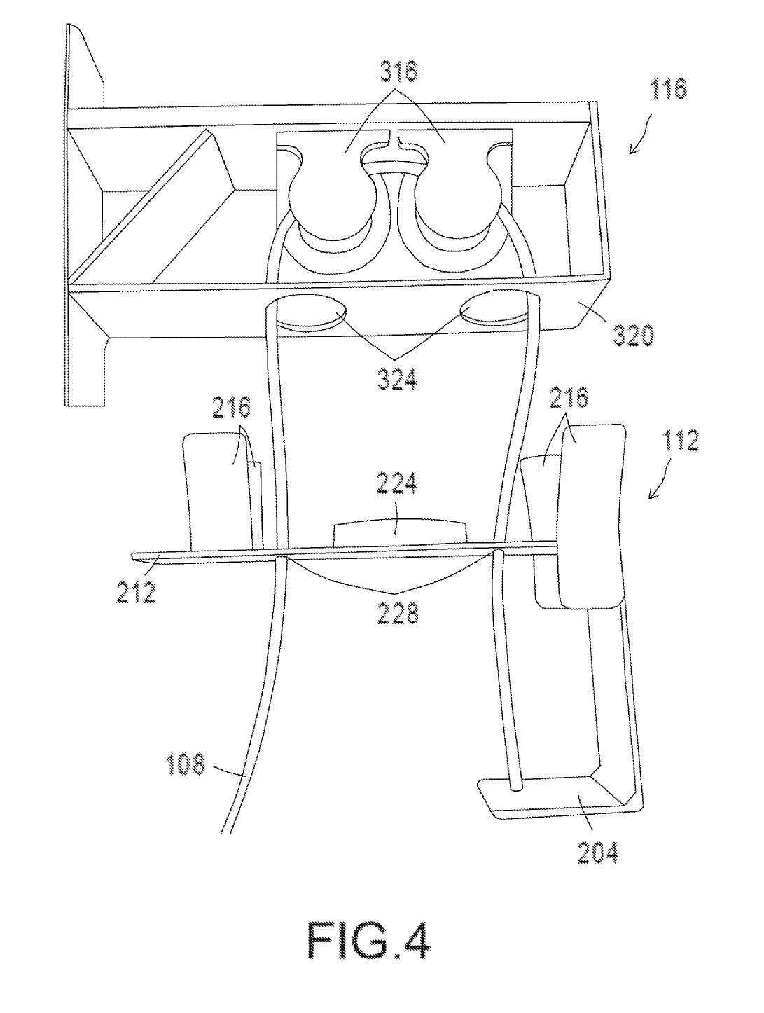

FIG. 4 is a view of a cable car 112 approaching an upper pulley assembly 116 to selectively interconnect with the upper pulley assembly 116. The top of the loop formed by the hoist cable 108 is depicted, and the cable car 112 is fixed to the hoist cable 108. The hoist cable 108 is positioned in one aperture 228 in the top plate 212 of the cable car 112, positioned in one aperture 324 in the bottom plate 320 of the upper pulley assembly 116, positioned in the two pulleys 316 of the upper pulley assembly 116, positioned in another aperture 324 in the bottom plate 320 of the upper pulley assembly 116, and positioned in another aperture 228 in the top plate 212 of the cable car 112. The position of the hoist cable 108 through the apertures 228, 324 promotes the alignment of the cable car 112 with the upper pulley assembly 116, particularly in the longitudinal, or end-to-end, dimension of the cable car 112. The position of the hoist cable 108 through the apertures 228, 324 also aligns the cable car 112 and the upper pulley assembly 116 with respect to a torsional or twisting motion of the cable car 112, which can preserve the integrity of monitoring devices mounted on the cable car 112.

In operation, the guide plates 216 on the upper plate 212 of the cable car 112 align the cable car 112 with the upper pulley assembly 116 as the cable car 112 is raised. The guide plates 216 are configured to catch or receive the lower plate 320 of the upper pulley assembly 116, then progressively align the cable car 112 with the upper pulley assembly 116 as the cable car 112 closes the distance with the upper pulley assembly 116. The guide plates 216 in this embodiment are angled away from the sides of the upper plate 212, and therefore, the guide plates 216 particularly align the cable car 112 with the upper pulley assembly 116 in the lateral, or side-to-side, dimension of the cable car 112.

While the cable car 112 in this embodiment is fixed to the hoist cable 108, there can be many configurations of the cable car 112 and hoist cable 108. For example, two ends of the hoist cable 108 can be fixed to the cable car 112 to form a loop instead of the cable car 112 being interconnected to a continuous loop of the hoist cable 108. Next, the cable car 112 may interconnect to the hoist cable 108 at another point on the cable car 112, or alternatively, one end of the hoist cable 108 may be attached to the top plate 212 and a second end of the hoist cable 108 may be attached to the cable mount 204. Further, the cable mount 204 may extend to the other leg of the hoist cable 108 that is not fixed to the cable mount 204, and the cable mount 204 may comprise an aperture in which the other leg of the hoist cable 108 is positioned. This provides additional alignment functionality in the longitudinal, or end-to-end, dimension of the cable car 112 as the cable car 112 is raised.

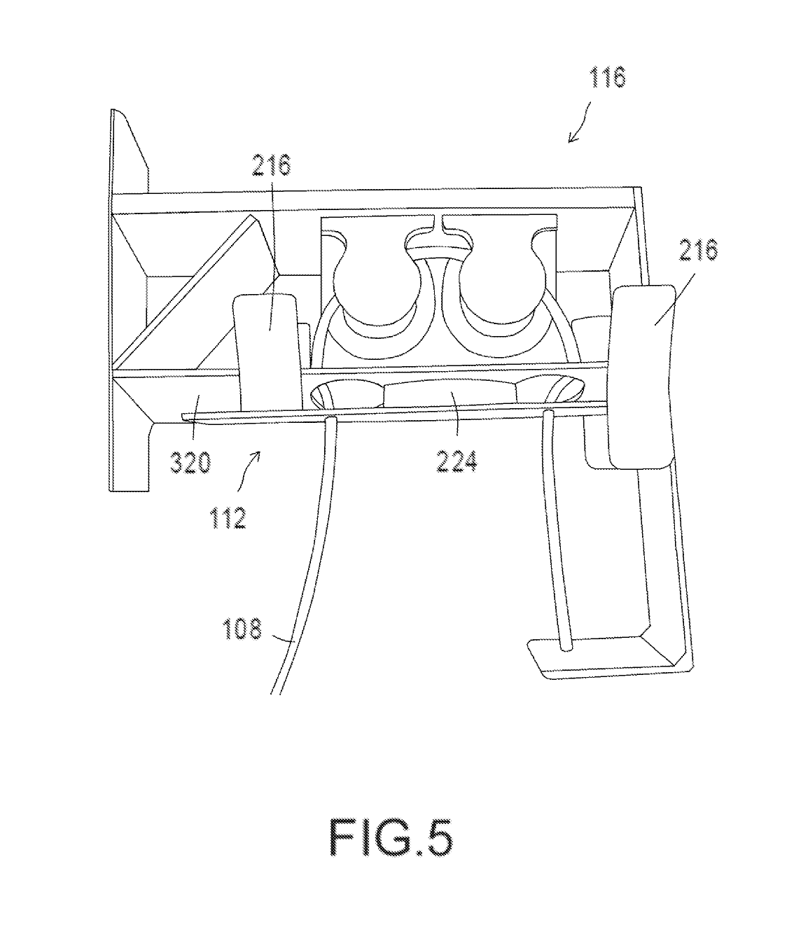

FIG. 5 shows the cable car 112 in a raised position and selectively interconnected to the upper pulley assembly 116. The cable-and-aperture configuration and the guide plates 216 aligned the cable car 112 with the upper pulley assembly 116, and the locating member 224 provides a magnetic force that is sufficient to maintain the cable car 112 at an elevated position above a ground surface.

Some embodiments of the hoist system 104 may comprise a second pulley assembly such that the cable car 112 can selectively interconnect to the second pulley assembly when the cable car 112 is in a lowered position. Monitoring devices mounted on a cable car in the raised position can be subjected to damage during turbulent environmental conditions, and a user may desire to secure the cable car in a lowered position where the cable car is selectively interconnected to the second pulley assembly. In some embodiments, the bottom of the loop formed by the hoist cable 108 may be positioned in at least one pulley in the second pulley assembly. In other embodiments, both legs of the hoist cable 108 pass completely through the second pulley assembly, and the bottom of the loop formed by the hoist cable 108 is positioned outside of the second pulley assembly. Thus, it is contemplated that a pulley assembly may be positioned at any point along the hoist cable 108.

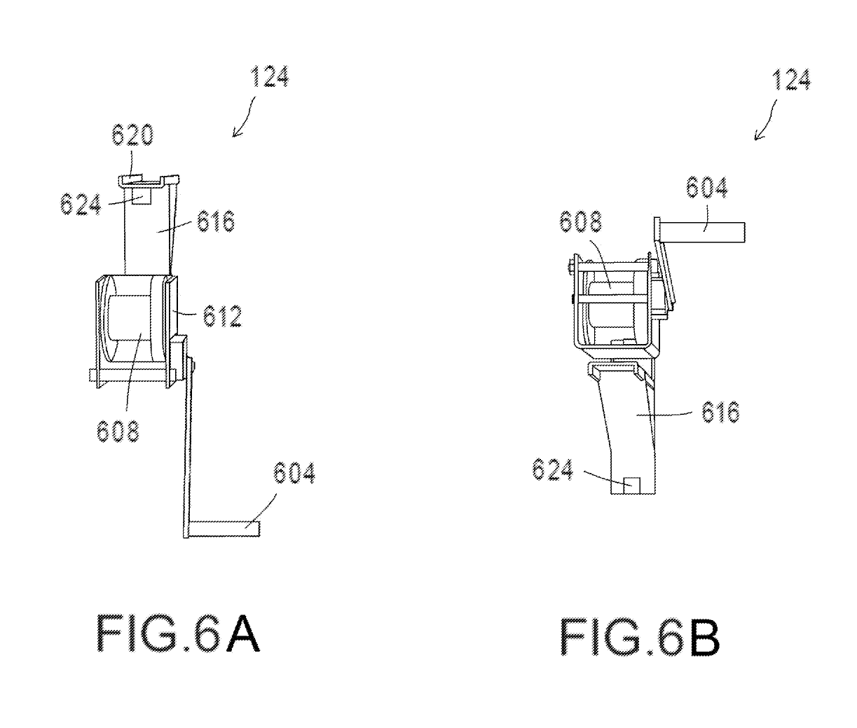

FIGS. 6A and 6B depict a winch assembly 124. As shown in this example, the winch assembly 124 can include a handle 604 connected to a drum 608, and a carrier 612 fixed to a winch mounting arm 616. The winch mounting arm 616 can include a mounting plate 620 with one or more band clamp guides 624 to facilitate fixing the winch assembly 124 to the mast 100, for example using band clamps or u-bolts that pass through the band clamp guides 624 and that loop around the mast 100. As can be appreciated by one of skill in the art after consideration of the present disclosure, the winch cable 128 is carried by the drum 608, and by turning the handle 604 and thus the drum 608 in the appropriate direction the hoist cable 108 can be selectively tensioned. As can be further appreciated, a winching assembly 124 may be utilized that directly manipulates the position of the hoist cable 108 to move the cable car 112 between a raised and lowered position.

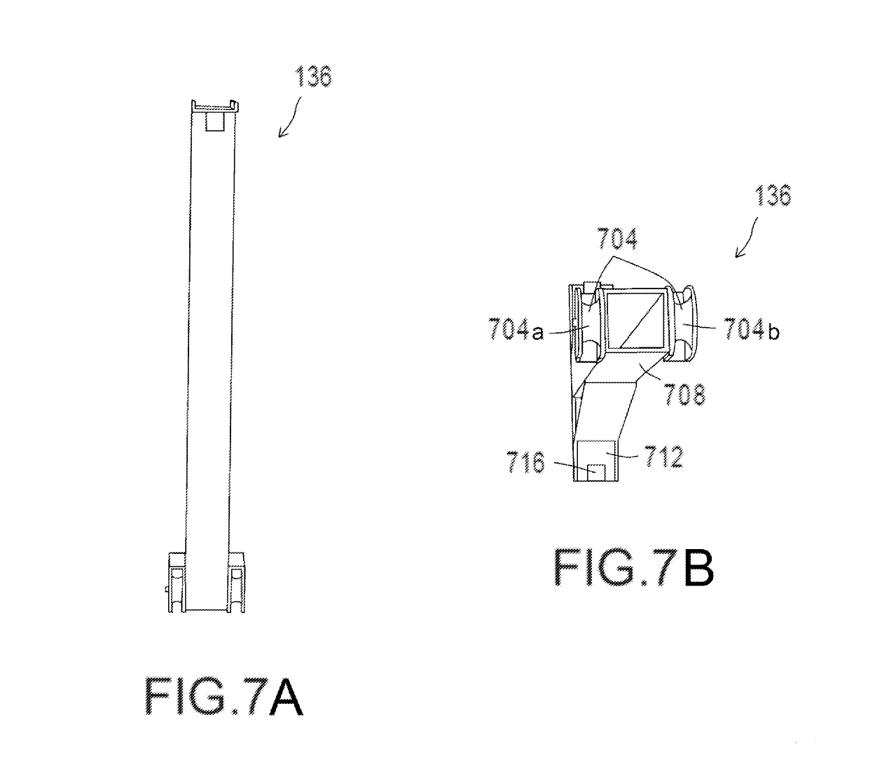

The bracing assembly 136, illustrated in FIGS. 7A and 7B, generally includes a pair of pulleys 704a, 704b mounted along a common axis to a bracing arm 708. The bracing arm 708 can incorporate or be connected to a mounting plate 712 with one or more band clamp guides 716 to facilitate fixing the bracing assembly to the mast 100, for example using band clamps or u-bolts. Various embodiments of the hoist system 104 may include no bracing assembly 136 or more than one bracing assembly 136 to maintain a desired spacing between the hoist cable 108 and the mast 100.

The hoist system 104 may be applied to different masts and towers, and thus, the components of the hoist system 104 can have many different sizes. However, exemplary dimensions of the components of the hoist system 104 may help one skilled in the art appreciate the present disclosure. For example, the height of the mast 100 in FIG. 1 can be approximately 80 m. The hoist cable 108 in FIG. 1 can be 330 feet long and 3/16 inches in diameter. The length of the cable car 112 in FIG. 2A can be 8½ inches, and the width of the cable car 112 can be 2 inches. The length of the upper pulley assembly 116 in FIG. 3A can be 9½ inches, and the width of the upper pulley assembly 116 can be 2 inches. The length of the winch assembly 124 in FIG. 6A from the distal end of the carrier 612 to the mounting plate 620 can be 9 inches, and the width of the winch assembly measured at the mounting plate 620 can be 2 inches. The length of the bracing assembly 136 in FIG. 7A can be 24 inches, and the width of the bracing assembly 136 can be 2 inches.

Accordingly, the present invention has been described with some degree of particularity directed to the exemplary embodiments of the present invention. It should be appreciated though that modifications or changes may be made to the exemplary embodiments of the present invention without departing from the inventive concepts contained herein.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A hoist system, comprising:
an upper pulley assembly having at least one pulley, the upper pulley assembly having a lower plate;
a hoist cable forming a loop, the hoist cable positioned in the at least one pulley of the upper pulley assembly; and
a cable car interconnected to the hoist cable, the cable car having at least one guide plate configured to align the cable car and the upper pulley assembly, the cable car having a locating member configured to selectively interconnect the cable car to the upper pulley assembly.

2. The hoist system of claim 1, further comprising:
a second locating member positioned on the lower plate of the upper pulley assembly.

3. The hoist system of claim 2, wherein the locating members are magnets having opposing polarities to attract and selectively interconnect to each other.

4. The hoist system of claim 1, further comprising:
a first aperture and a second aperture in the lower plate of the upper pulley assembly;
a third aperture and a fourth aperture in an upper plate of the cable car;
wherein the hoist cable is positioned in the first aperture, the second aperture, the third aperture, and the fourth aperture.

5. The hoist system of claim 4, further comprising:
a second locating member positioned on the lower plate of the upper pulley assembly, wherein the second locating member is positioned between the first aperture and the second aperture in the lower plate of the upper pulley assembly.

6. The hoist system of claim 4, wherein the locating member is positioned between the third aperture and the fourth aperture in the upper plate of the cable car.

7. The hoist system of claim 1, further comprising:
a winch cable operatively interconnected to the hoist cable;
a winch assembly that tensions the winch cable.

8. The hoist system of claim 1, further comprising:
a mounting plate positioned on the cable car;
a monitoring device positioned on the mounting plate, wherein the monitoring device is a sound recording device.

9. The hoist system of claim 1, further comprising:
a mast oriented substantially perpendicular to a ground surface, wherein the upper pulley assembly is interconnected to the mast; and
a bracing assembly interconnected to the mast, the bracing assembly having at least one pulley wherein the hoist cable is positioned in the at least one pulley of the bracing assembly.

10. The hoist system of claim 1, wherein the first locating member of the upper pulley assembly is a guide tube.

11. A method for hoisting a cable car, comprising:
moving a hoist cable, which forms a loop, to raise a cable car to an upper pulley assembly, wherein the cable car is interconnected to the hoist cable, and the hoist cable is positioned in at least one pulley of the upper pulley assembly;
aligning the cable car and the upper pulley assembly with at least one guide plate positioned on an upper plate of the cable car;
selectively interconnecting a locating member positioned on the upper plate of the cable car to a lower plate of the upper pulley assembly.

12. The method of claim 11, further comprising:
providing a second locating member on the lower plate of the upper pulley assembly.

13. The method of claim 12, wherein the locating members are magnets having opposing polarities to attract and selectively interconnect to each other.

14. The method of claim 11, further comprising:
providing a first aperture and a second aperture in the lower plate of the upper pulley assembly;
providing a third aperture and a fourth aperture in the upper plate of the cable car;
positioning the hoist cable in the first aperture, the second aperture, the third aperture, and the fourth aperture.

15. The method of claim 14, further comprising:
providing a second locating member on the lower plate of the upper pulley assembly, wherein the second locating member is positioned between the first aperture and the second aperture in the lower plate of the upper pulley assembly.

16. The method of claim 14, wherein the locating member is positioned between the third aperture and the fourth aperture in the upper plate of the cable car.

17. The method of claim 11, further comprising:
operatively interconnecting a winch cable to the hoist cable;
tensioning the winch cable with a winch assembly.

18. The method of claim 11, further comprising:
providing a mounting plate on the cable car;
providing a monitoring device positioned on the mounting plate, wherein the monitoring device is a sound recording device.

19. The method of claim 11, further comprising:
providing a mast oriented substantially perpendicular to a ground surface, wherein the upper pulley assembly is interconnected to the mast; and
providing a bracing assembly interconnected to the mast, the bracing assembly having at least one pulley wherein the hoist cable is positioned in the at least one pulley of the bracing assembly.

20. The method of claim 11, wherein the first locating member of the upper pulley assembly is a guide tube.
